(19) United States
(12) Patent Application Publication
(10) Pub. No.: US 2019/0128443 A1
(43) Pub. Date: May 2, 2019

(54) Pressure-Balanced Pull-Type Manual Actuation Mechanism for a Valve

(71) Applicant: Sun Hydraulics, LLC, Sarasota, FL (US)

(72) Inventor: Bernd Zähe, Sarasota, FL (US)

(21) Appl. No.: 15/797,177

(22) Filed: Oct. 30, 2017

(51) Int. Cl. F16K 35/02; F16K 1/30; F16K 1/12; F16K 31/60; F16K 31/06

(52) U.S. Cl. CPC F16K 35/027; F16K 1/30; F16K 31/0693; F16K 31/60; F16K 1/12

(57) ABSTRACT

An example manual actuation mechanism includes (i) a piston having: (a) a first flanged portion with a first annular surface area, (b) a second flanged portion with a second annular surface area, (c) a longitudinal cavity bounded by an interior peripheral surface of the piston, and (d) a shoulder on the interior peripheral surface of the piston; and (ii) a pin disposed in the longitudinal cavity of the piston, where the pin has an area with an enlarged diameter configured to interface with and rest against the shoulder of the piston, such that a force applied on the pin in a given axial direction is transferred to the piston, and where a difference between the second annular surface area of the second flanged portion and the first annular surface of the first flanged portion is substantially equal to a cross-sectional area of the pin.

### BACKGROUND

A hydraulic valve directs the flow of a liquid medium, usually oil, through a hydraulic system. The direction of the oil flow is determined by the position of a spool or a poppet. An example valve may have a movable element inside a housing or sleeve. For instance, the valve may include a poppet that is movable by an actuation mechanism (e.g., electric, hydraulic, pneumatic, or manual). The poppet may be seated on a valve seat formed inside the housing. Once the valve is actuated, the poppet moves off the seat to allow flow around the poppet from a first port to a second port.

In examples, if the valve is a manually-actuated valve, then to actuate the valve, an operator may apply a large force to a knob or a similar element to overcome a large spring force applied by a spring having a high spring rate and cause the poppet to be unseated. If the valve is electrically-actuated, e.g., via a solenoid, in some cases, the solenoid fails and it may be desirable to have a manual override feature to allow the valve to be manually activated to place a machine in a safe condition. Using the manual override feature would also involve applying the large force that overcomes the aforementioned large spring force.

Further, in some examples, it may be desirable to include a detent mechanism in the valve such that when the valve is actuated, e.g., manually, the operator moves a lever or a knob until the detent mechanism is engaged. Once the detent mechanism is engaged, the operator can release the lever or knob, while the movable element remains locked in place. In the case of a large spring force, the detent mechanism is configured to be able to oppose the large spring force, and as such the detent mechanism may be complicated and costly.

Therefore, it may be desirable to have a valve that has a manual actuation mechanism that enables using a soft spring having a small spring rate such that the manual actuation force is reduced, and the complexity and cost of an associated detent mechanism is also reduced.

### SUMMARY

The present disclosure describes implementations that relate to pressure-balanced pull-type manual actuation mechanism for a valve. In a first example implementation, the present disclosure describes a pull-type manual actuation mechanism for a valve. The pull-type manual actuation mechanism includes: (i) a piston having: (a) a first flanged portion with a first annular surface area, (b) a second flanged portion with a second annular surface area, where the first flanged portion and the second flanged portion project from an exterior peripheral surface of the piston, (c) a longitudinal cavity bounded by an interior peripheral surface of the piston, and (d) a shoulder on the interior peripheral surface of the piston; and (ii) a pin disposed in the longitudinal cavity of the piston, where the pin has an area with an enlarged diameter configured to interface with and rest against the shoulder of the piston, such that a force applied on the pin in a given axial direction is transferred to the piston, and where a difference between the second annular surface area of the second flanged portion and the first annular surface of the first flanged portion is substantially equal to a cross-sectional area of the pin.

In a second example implementation, the present disclosure describes another pull-type manual actuation mechanism for a valve. The pull-type manual actuation mechanism includes: (i) a knob having a first longitudinal cavity therein; (ii) a sleeve disposed in the first longitudinal cavity coaxial with the knob, where the sleeve has a second longitudinal cavity therein; (iii) a piston disposed in the second longitudinal cavity coaxial with the sleeve, where the knob is coupled to the piston such that as the knob is pulled in a given axial direction, the piston moves in the given axial direction along with the knob, where the piston has: (a) a first flanged portion having a first annular surface area, (b) a second flanged portion having a second annular surface area, where the first flanged portion and the second flanged portion project from an exterior peripheral surface of the piston, (c) a third longitudinal cavity bounded by an interior peripheral surface of the piston, and (d) a shoulder on the interior peripheral surface of the piston; and (iv) a pin disposed and axially movable in the third longitudinal cavity of the piston, where an end of the pin is configured to be subjected to pressurized fluid from an inlet of the valve, where the pin has an area with an enlarged diameter configured to interface with and rest against the shoulder of the piston, such that a force applied on the end of the pin via the pressurized fluid in the given axial direction is transferred to the piston, and where a difference between the second annular surface area of the second flanged portion and the first annular surface of the first flanged portion is substantially equal to a cross-sectional area of the pin.

In a third example implementation, the present disclosure describes a valve. The valve includes: (i) a main valve section; and (ii) a pull-type manual actuation mechanism. The main valve section includes a housing; a sleeve disposed in the housing, where the sleeve defines a first port and a second port; and a movable element configured to move axially within the sleeve. The pull-type manual actuation mechanism includes: (i) a knob having a first longitudinal cavity therein; (ii) a piston disposed partially within the first longitudinal cavity, where the knob is coupled to the piston, where the piston has: (a) a first flanged portion having a first annular surface area, (b) a second flanged portion having a second annular surface area, where the first flanged portion and the second flanged portion project from an exterior peripheral surface of the piston, and (c) a second longitudinal cavity bounded by an interior peripheral surface of the piston, and (d) a shoulder on the interior peripheral surface of the piston; and (iii) a pin disposed in the second longitudinal cavity of the piston, where the pin is coupled to the movable element of the main valve section, where the pin has an area with an enlarged diameter configured to interface with and rest against the shoulder of the piston, such that a force applied on the pin in a given axial direction via pressurized fluid received at the second port acting on a cross-sectional area of the pin is transferred to the piston. A difference between the second annular surface area of the second flanged portion and the first annular surface area of the first flanged portion is substantially equal to the cross-sectional area of the pin, such that when pressurized fluid is communicated to the first annular surface area and the second annular surface area, the piston is pressure-balanced. When the knob is pulled in the given axial direction, the piston moves in the given axial direction along with the knob, allowing the pin and the movable element coupled thereto to move in the given axial direction, thereby allowing fluid to flow from the second port to the first port.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

FIG. 1A illustrates a cross section of an example valve in a closed position, in accordance with an example implementation.

FIG. 1B illustrates a zoomed-in view of a portion of the valve shown in FIG. 1A, in accordance with an example implementation

FIG. 2A illustrates the valve of FIG. 1A including a detent mechanism while the valve is in a closed state and the detent mechanism is disengaged, in accordance with an example implementation.

FIG. 2B illustrates the valve of FIG. 2A locked in an open state with the detent mechanism in an engaged state, in accordance with another example implementation.

FIG. 3 illustrates a cross-sectional view of a valve, in accordance with an example implementation.

FIG. 4 illustrates a cross-sectional view of another valve, in accordance with an example implementation.

FIG. 5 illustrates a flowchart of an example method of operating a valve, in accordance with an example implementation.

### DETAILED DESCRIPTION

In examples, a normally-closed valve may have a poppet that is seated on a seat formed as a protrusion from an interior peripheral surface of a cage, sleeve, valve body, or housing. When the valve is actuated, the poppet is unseated and moves within the valve body to form a gap between an exterior peripheral surface of the poppet and the seat, thereby allowing fluid to flow from an inlet through the gap to an outlet. The valve may be a proportional valve where an axial position of the poppet affects the amount the flow rate across the valve for a given pressure drop between the inlet and the outlet.

In examples, the poppet may be unseated using an electric force applied by a solenoid or by direct manual actuation. If the poppet is unseated via a solenoid, it may be desirable to have a manual-override feature to allow manual actuation of the valve in the case of a solenoid failure. An example manual actuation of the valve may have a movable element, such as a pin, that is subjected to inlet pressure of the valve, which could be as high as 6000 psi. The inlet pressure thus applies a large force on the pin. For instance, for a pin having a diameter of 0.078 inches, the force may be 28.65 lbs. To maintain the pin within a particular chamber of the valve and preclude it from moving when subjected to pressure spikes at the inlet of the valve, a spring with a large spring rate is disposed in the manual actuation mechanism to oppose the large force applied to the pin. For instance, the spring may be configured to apply a force of about 30 to 35 lbs or more to oppose the force applied to the pin. Whether the valve is manually actuated or includes a manual override feature, to actuate the valve, an operator may apply a large force against the large spring force and against friction of seals and other springs within the valve. Such large force that the operator applies may be difficult to achieve and may lead to operator fatigue.

Further, in some valve configurations, the pressure at the inlet is communicated to the manual actuation mechanism and the operator may apply a force that opposes both the spring force and the inlet pressure applied on a component within the manual actuation mechanism. As the poppet is unseated, the pressure at the inlet collapses as fluid flows from the inlet to the outlet. Thus, the force that the operator has been applying to overcome an initial large inlet pressure and the spring may cause the poppet to suddenly move a large axial distance, thus allowing a large flow rate across the valve. This configuration renders the valve operating as an on-off valve, not a proportional valve as may be desired. Such sudden increase in flow rate may cause an actuator (e.g., a cylinder or motor) controlled by the valve to move faster than expected, which may be undesirable.

Thus, it may be desirable to configure the valve such that the manual actuation mechanism is pressure-balanced regardless of the pressure level at the inlet. This way, a soft spring may be used rather than a stiff spring having a large spring rate. Also, a pressure-balanced configuration is insensitive to the pressure level at the inlet, and thus the operator can operate the valve proportionally as the change in pressure level at the inlet does not affect the amount of force that the operator applies to move the poppet.

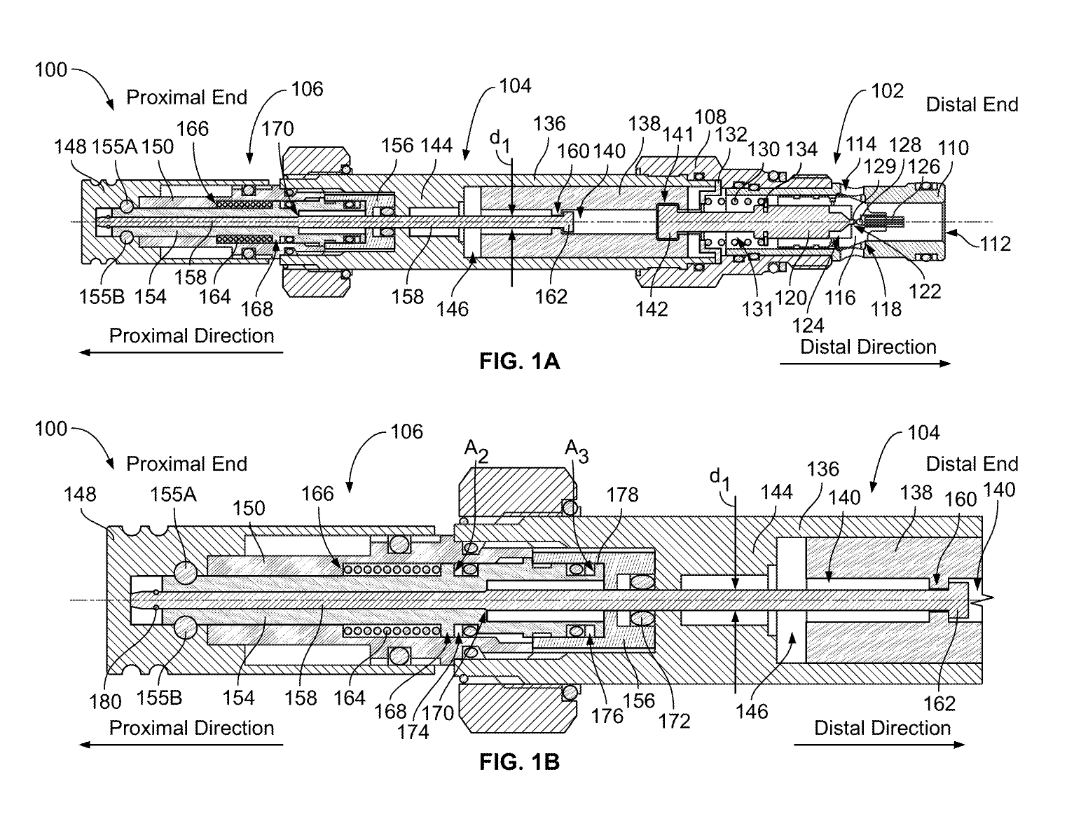

FIG. 1A illustrates a cross section of an example valve 100 in a closed position, in accordance with an example implementation. The valve 100 may include a main valve section 102, a pull-type solenoid actuator mechanism 104, and a pull-type manual actuation mechanism 106.

The main valve section 102 includes a housing 108 that defines a longitudinal cylindrical cavity therein. The longitudinal cylindrical cavity of the housing 108 is configured to receive at a distal or first end thereof a cage or sleeve 110 coaxial with the housing 108. The sleeve 110 defines a first port 112 and a second port 114. The first port 112 is defined at a nose of the sleeve 110, whereas the second port 114 may be defined as holes disposed in a radial array about an exterior surface of the sleeve 110. The valve 100 is configured to control flow of fluid between the second port 114 and the first port 112.

The sleeve 110 defines a respective longitudinal cylindrical cavity therein, and a first poppet 116 is disposed in the cavity defined within the sleeve 110, where the first poppet 116 is coaxial with the housing 108 and the sleeve 110. The first poppet 116 could also be referred to as a main or primary poppet.

In the closed position shown in FIG. 1A, the first poppet 116 is seated on a seat 118 defined by an interior peripheral surface of the sleeve 110. The first poppet 116 has a respective tapered circumferential surface that contacts the seat 118 when the first poppet 116 is seated.

The first poppet 116 defines a respective longitudinal cylindrical cavity therein. A second poppet 120 is disposed in the cavity defined within the first poppet 116, and the second poppet 120 is coaxial with the housing 108, the sleeve 110, and the first poppet 116. The second poppet 120 may also be referred to as a dart or secondary poppet.

In the closed position shown in FIG. 1A, the second poppet 120 is seated on a seat 122 defined by an interior peripheral surface of the first poppet 116. The second poppet 120 has a respective tapered circumferential surface that contacts the seat 122 when the second poppet 120 is seated. Further, a chamber 124 is defined within the first poppet 116 between an exterior peripheral surface of the second poppet 120 and the interior peripheral surface of the first poppet 116.

The valve 100 further includes a roll pin 126 coupled to a ball 128 (e.g., a metal sphere) that operates as a check valve. The roll pin 126 and the ball 128 are disposed within the first poppet 116 at a nose section or a distal end thereof. The ball 128 blocks a longitudinal passage or longitudinal channel 129 defined in the distal end of the first poppet 116, and thus the ball 128 blocks fluid flow from the first port 112 through the nose section of the first poppet 116 and the longitudinal channel 129 to the chamber 124 when the second poppet 120 is unseated. However, when the second poppet 120 is unseated, fluid flows from the chamber 124 though the longitudinal channel 129, pushing the ball 128 and the roll pin 126, to flow to the first port 112.

The valve 100 further includes a spring 130 disposed in a chamber 131 defined within the sleeve 110 and the housing 108. The spring 130 is disposed around an exterior peripheral surface of the second poppet 120 between a spring support member 132 fixedly disposed in the longitudinal cavity of the housing 108 and a washer or retaining ring 134 disposed in a groove defined in the exterior surface of the second poppet 120. The spring 130 applies a force on the retaining ring 134, and thus on the second poppet 120, in a closing distal direction (e.g., to the right in FIG. 1A). As a result of the force applied by the spring 130 on the second poppet 120, the second poppet 120 remains seated at the seat 122.

The second poppet 120 is configured to move axially in the cavity defined within the first poppet 116 when the valve 100 is actuated by any type of actuation mechanisms. As depicted in FIG. 1A, the valve 100 includes the pull-type solenoid actuator mechanism 104 configured to move the second poppet 120; however, other actuation mechanisms could be used.

In examples, the pull-type solenoid actuator mechanism 104 may include a solenoid tube 136 disposed within and received at a proximal or second end of the housing 108, such that the solenoid tube 136 is coaxial with the housing 108. A solenoid coil (not shown) may be disposed about an exterior surface of the solenoid tube 136.

The solenoid tube 136 is configured to house a plunger or armature 138. The armature 138 defines therein a longitudinal channel 140. The armature 138 also defines an annular internal groove 141 on an interior peripheral surface of the armature 138, where the annular internal groove 141 is formed as a recessed portion from the longitudinal channel 140 and is configured to receive an enlarged proximal end 142 of the second poppet 120. With this configuration, the second poppet 120 is coupled to the armature 138, and thus, axial motion of the armature 138 causes the second poppet 120 to move axially as well.

Further, the solenoid tube 136 defines a pole piece 144 formed as a protrusion from an interior peripheral surface of the solenoid tube 136. The pole piece 144 is separated from the armature 138 by an airgap 146. The pole piece 144 may be composed of material of high magnetic permeability.

When an electric current is provided through the windings of the solenoid coil, a magnetic field is generated. The pole piece 144 directs the magnetic field through the airgap 146 toward the armature 138, which is movable and is attracted toward the pole piece 144. In other words, when an electric current is applied to the solenoid coil, the generated magnetic field forms a north and south pole in the pole piece 144 and the armature 138, and therefore the pole piece 144 and the armature 138 are attracted to each other. Because the pole piece 144 is fixed as part of the solenoid tube 136 and the armature 138 is movable, the armature 138 traverses the airgap 146 toward the pole piece 144.

As the armature 138 moves toward the pole piece 144, the second poppet 120 also moves axially against a force of the spring 130 and is thus unseated off the seat 122. As a result, fluid in the chamber 124 is allowed to flow through the longitudinal channel 129, thereby pushing the ball 128 and the roll pin 126, and then flowing to the first port 112. The first port 112 may be fluidly coupled to a low pressure reservoir or tank. Thus, the pressure level in the chamber 124 is reduced as the fluid is vented from the chamber 124 through the first port 112 to the tank.

The second port 114 may be fluidly coupled to a source of pressurized fluid (e.g., a pump or accumulator). The pressurized fluid received at the second port 114 applies a force on a tapered exterior peripheral surface of a nose or distal end of the first poppet 116. Because of the difference in pressure level between the fluid received at the second port 114 and the fluid in the chamber 124, the first poppet 116 is moved axially in a proximal direction (e.g., to the left in FIG. 1A) and is unseated off the seat 118. Thus, a gap or flow area is formed between the exterior surface of the first poppet 116 and the interior peripheral surface of the sleeve 110, thus allowing fluid to flow from the second port 114 around the first poppet 116 through the flow area to the first port 112.

In some cases, the pull-type solenoid actuator mechanism 104 might fail, might become inoperable, or might not operate as expected. In these cases, sending an electric signal to the windings of the solenoid coil might not cause the first poppet 116 to be unseated. As a safety feature, it may be desirable for the valve 100 to include the pull-type manual actuation mechanism 106 that allows an operator to manually override the pull-type solenoid actuator mechanism 104. Specifically, the pull-type manual actuation mechanism 106 may allow the operator to manually pull the armature 138 toward the pole piece 144 to unseat the second poppet 120, which causes the first poppet 116 to be unseated, thus allowing flow from the second port 114 to the first port 112 as described above. In some examples, the valve 100 might not include the pull-type solenoid actuator mechanism 104, and the pull-type manual actuation mechanism 106 operates as the actuation mechanism for the valve 100.

The pull-type manual actuation mechanism 106 includes a knob 148 that defines a respective longitudinal cylindrical cavity therein. A sleeve 150 is fixedly disposed partially in the cavity defined within the knob 148 and partially in a cavity defined within a proximal end of the solenoid tube 136. The sleeve 150 is coaxial with the knob 148 and the solenoid tube 136.

Further, the sleeve 150 defines a respective longitudinal cylindrical cavity therein and houses a piston 154 that is axially movable within the longitudinal cylindrical cavity of the sleeve 150. The piston 154 may include one or more grooves on an exterior peripheral surface thereof that correspond to respective one or more grooves in the interior peripheral surface of the knob 148, such that roll pins 155A and 155B are disposed partially in the grooves of the piston 154 and partially in the grooves of the knob 148. With this configuration, the knob 148 is coupled to the piston 154, such that moving the knob 148 axially causes the piston 154 to move axially therewith.

A spacer 156, which may be ring-shaped, is disposed within the cavity defined at the proximal end of the solenoid tube 136. The spacer 156 interfaces with the sleeve 150 and is configured to house a portion of the piston 154 in a cavity defined within the spacer 156.

The piston 154 also defines therein a respective longitudinal cylindrical cavity that houses a pin 158. The pin 158 extends longitudinally between the knob 148 and the armature 138 such that the pin 158 is disposed partially within the knob 148, partially within the piston 154 and the sleeve 150, partially within the spacer 156, partially within the solenoid tube 136, and partially within the armature 138.

The armature 138 includes a protrusion 160 emanating from the interior peripheral surface of the armature 138 into the longitudinal channel 140 to define a restriction therein through which the pin 158 is disposed. The pin 158 has an enlarged distal end 162 disposed in a recessed area of the interior peripheral surface of the armature 138 formed as a result of the protrusion 160. With this configuration, if the pin 158 is moved axially in a proximal direction (e.g., to the left in FIG. 1A), the enlarged end 162 of the pin 158 engages the protrusion 160 of the armature 138, thus causing the armature 138 to move axially along with the pin 158. As described above, axial motion of the armature 138 causes the second poppet 120 to move axially therewith due to the engagement of the enlarged proximal end 142 of the second poppet 120 with the armature 138. As such, the pin 158 is indirectly coupled to the second poppet 120 via the armature 138.

The pull-type manual actuation mechanism 106 further includes a spring 164 disposed about an exterior peripheral surface of the piston 154 within the cavity defined by the sleeve 150. The spring 164 is supported between a shoulder 166 defined by the interior peripheral surface of the sleeve 150 and a flanged portion 168 defined as a rim, collar, or rib projecting from the exterior peripheral surface of the piston 154.

The sleeve 150 is fixed, whereas the piston 154 is axially movable therein. Thus, the spring 164 applies a force on the piston 154 that maintains the piston 154 biased in a distal direction, e.g., to the right in FIG. 1A.

Further, the piston 154 defines a shoulder 170 (e.g., a stepped surface with a reduction in internal diameter of the piston 154) against which the pin 158 rests. Specifically, the pin 158 may define a shoulder (a stepped surface) with an enlarged diameter that rests against the shoulder 170, such that forces applied to the pin 158 in the proximal direction (e.g., to the left in FIG. 1) are transferred to the piston 154 via the shoulder 170.

In operation, pressurized fluid may be received at the second port 114 as described above. The pressurized fluid is communicated through unsealed space between the interior peripheral surface of the sleeve 110 and the exterior peripheral surface of the first poppet 116 to the chamber 131 within which the spring 130 is disposed. The pressurized fluid is then communicated around the second poppet 120 and through unsealed space between the interior peripheral surface of the armature 138 and the exterior peripheral surface of the second poppet 120 to the longitudinal channel 140.

The pressurized fluid in the longitudinal channel 140 applies a force on the pin 158 in a proximal direction, e.g., to the left in FIG. 1. This force may be estimated as the pressure level of the pressurized fluid in the longitudinal channel 140 multiplied by cross-sectional area “A₁” of the pin 158 that is equal to πd₁²/4 where “d₁” is the diameter of the pin 158 as labelled in FIG. 1A. The area “A₁” is the difference between an area of an end face of the enlarged end 162 of the pin 158 and an annular area on the other side of the enlarged end 162, which interfaces with the protrusion 160. Thus, assuming that the pressure level of the pressurized fluid “P,” then the force applied to the pin 158 is =PA₁. This force acts in a first (proximal) axial direction, e.g., to the left in FIG. 1A, and the force is transferred to the piston 154 via the shoulder 170.

FIG. 1B illustrates a zoomed-in view of a portion of the valve 100, in accordance with an example implementation. The pressurized fluid in the longitudinal channel 140 is further communicated around the pin 158 to the cavity at the proximal end of the solenoid tube 136, which houses the spacer 156. The pressurized fluid may then push an O-ring 172 axially in the proximal direction (e.g., to the left in FIG. 1B) in a cavity or axial space defined between an interior peripheral surface of the spacer 156 and the exterior peripheral surface of the pin 158.

The pressurized fluid is then communicated around the spacer 156 through an unsealed space between the exterior surface of the spacer 156 and the interior surface of the solenoid tube 136 to the exterior peripheral surface of the piston 154 as indicated by the thick arrows depicted in FIG. 1B. The pressurized fluid is thus communicated to a first groove 174 and a second groove 176 defined in the exterior peripheral surface of the piston 154. The first groove 174 is bounded by the flanged portion 168 and the second groove 176 is bounded by a flanged portion 178 defined at a distal end of the piston 154.

The pressurized fluid thus applies a force on an annular surface area “A₂” of the flanged portion 168 in the first (proximal) axial direction, and applies a force on an annular surface area “A₃” of the flanged portion 178 in a second (distal) axial direction opposite the first (proximal) axial direction. Therefore, the resultant force acting on the piston 154 can be estimated by the following equation:

F=PA₁+PA₂−PA₃=P(A₁+A₂−A₃) (1)

The valve 100 is configured such that the area difference A₃−A₂ is substantially equal to the area A₁. The term “substantially” is used, for example, to indicate that the area difference A₃−A₂ is equal to the area A₁ or within a threshold area or percentage area (e.g., ±1-3%) from the area A₁. As a result, (A₁+A₂−A₃) is substantially equal to zero, and thus the force “F” defined by equation (1) is substantially equal to zero (e.g., within a threshold force value, such as 1 lbs, from zero lbs).

With this configuration, the piston 154 is pressure-balanced as the pressurized fluid communicated from the second port 114 exerts opposing forces on the piston 154 on surface areas that are selected such that the resultant force exerted on the piston 154 is substantially equal to zero. As a result, the spring 164 could be configured as a soft spring having a small spring rate that is sufficient to bias the piston 154 and the pin 158 in the distal direction (e.g., to the right in FIG. 1B) to maintain the second poppet 120 seated and the valve 100 closed. For example, the spring 164 may exert a small force in a range between 2 lbs and 4 lbs. As an example for illustration, the spring 164 may have a spring rate of about 20 lbs/inch, and thus if the spring 164 is compressed by 0.15 inches, then the spring 164 applies a force of 3 lbs on the piston 154.

As an example for illustration, assuming that the diameter “d₁” is 0.08 inches, then the cross-sectional area “A₁” can be determined to be about 0.005 square inches. Assuming that the pressure level “P” is about 5000 psi, then the force applied on the pin 158 in the first (proximal) direction can be determined to be about 25 lbs. If the piston 154 is not pressure-balanced, then the spring 164 would be designed to be a stiff spring to oppose such high force. For instance, the spring 164 would be configured to exert a force of about 30 lbs. However, with the configuration described above where the area difference A₃−A₂ is substantially equal to A₁, the piston 154 is pressure-balanced, and the spring 164 could be configured as a soft spring with a small spring rate, and the spring 164 applies a small force (e.g., 2-4 lbs) to maintain the valve 100 closed.

The pressure-balanced configuration enabling the spring 164 to be a soft spring, enhances operation of the pull-type manual actuation mechanism 106. When an operator pulls the knob 148 to manually actuate the valve 100, the operator overcomes the force of the spring 164 to move the piston 154 in the proximal direction in addition to other resisting force resulting from seal friction for example and the spring 130. If the spring 164 has a high spring rate causing a large force (e.g., 30 lbs), then the operator applies a large force (e.g., 36 lbs) to be able to overcome the spring 164 and move the piston 154. However, if the spring 164 is a soft spring with a small spring rate causing a small force (e.g., 4 lbs), then the operator applies a corresponding small force (e.g., 12-18 lbs) to be able to overcome the spring 164, friction forces, and the spring 130, and move the piston 154. This way, operator fatigue may be avoided as the effort exerted in operating the pull-type manual actuation mechanism 106 is reduced.

Further, with the pressure-balanced configuration, operation of the pull-type manual actuation mechanism 106 is insensitive to variation of the pressure level “P” at the second port 114. The pressure level “P” may change during operation of the valve 100. For instance, as soon as the first poppet 116 is moved off the seat 118, the pressure level “P” at the second port 114 may collapse (e.g., may be reduced at a high rate of pressure reduction). However, regardless of the pressure level “P,” the pressurized fluid is communicated to the pull-type manual actuation mechanism 106 and applies forces on the areas A₁, A₂, and A₃ as described above, and the piston 154 is maintained in a pressure-balanced state. Thus, regardless of the variation of the pressure level “P,” the operator overcomes a fixed spring force of the spring 164, friction forces, and the force of the spring 130.

This way, consistent operation of the pull-type manual actuation mechanism 106 is achieved. In other words, for a given pulling force level that the operator applies on the knob 148, the piston 154 moves proximally a corresponding axial distance that is consistent regardless of the pressure level “P.” Thus, proportional control of the valve 100 via manual actuation is enabled.

As the piston 154 moves axially in the proximal direction (e.g., to the left in FIGS. 1A-1B) when the operator pulls the knob 148, the pressurized fluid in the longitudinal channel 140 applies a force on the pin 158 (e.g., on the enlarged end 162) that causes the pin 158 to also move axially in the proximal direction. In some cases, the pressure level “P” in the longitudinal channel 140 might be low and might not be sufficient to apply a force on the pin 158 to move it in the proximal direction. As such, a wire 180 (e.g., a protrusion) is disposed about the exterior peripheral surface of the pin 158 toward the proximal end thereof that enables the piston 154 to move the pin 158 when the pressure level “P” is low. Particularly, the interior peripheral surface of the piston 154 engages with the wire 180 as the piston 154 move in the proximal direction, and thus the piston 154 drags the pin 158 along in the proximal direction.

As the pin 158 move axially in the proximal direction, the pin 158 applies a force on the armature 138 via the protrusion 160, thus causing the armature 138 to also move axially in the proximal direction. Referring back to FIG. 1A, as the armature 138 moves axially in the proximal direction, the armature 138 causes the second poppet 120 to also move axially in the same direction as a result of the enlarged proximal end 142 being coupled to the armature 138. The second poppet 120 thus moves off the seat 122, which causes the first poppet 116 to move off the seat 118 to follow the second poppet 120 as described above. As a result, the valve 100 is activated manually by pulling the knob 148.

In some examples, the operator pulls the knob 148 and holds the knob 148 in a pulled position to maintain the valve 100 in an activated state; however, if the operator releases the knob 148, the valve 100 returns to an unactivated (closed) state. In other examples, a detent mechanism may be added to the valve 100 to enable the operator to release the knob 148, yet lock the valve 100 in an open or activated state.

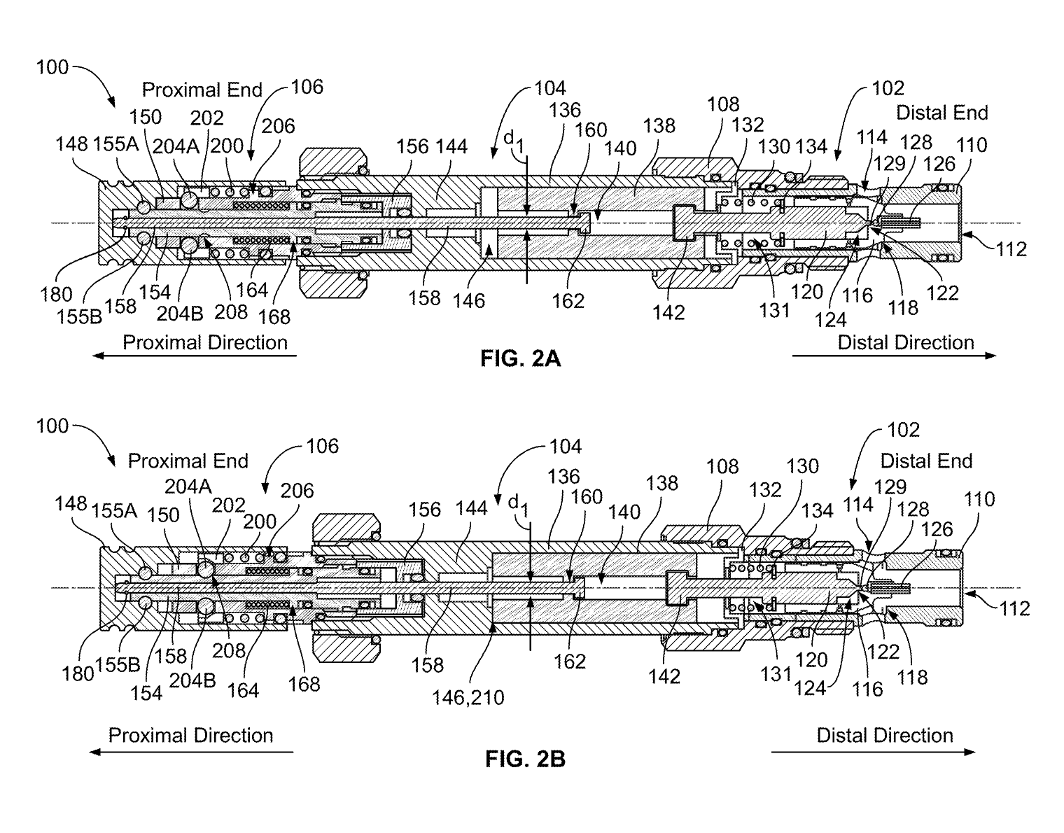

FIG. 2A illustrates the valve 100 including a detent mechanism while the valve 100 is in a closed state and the detent mechanism is disengaged, in accordance with an example implementation. The detent mechanism may include, for example, a spring 200, a spacer 202, and a plurality of balls (e.g., metal spheres), such as balls 204A, 204B. The balls of the detent mechanism may be disposed in respective holes formed in the sleeve 150, and the balls may be disposed in a radial array about the sleeve 150. FIG. 2A depicts the two balls 204A, 204B; however, in other example implementations, more or fewer balls could be used. For instance, four balls may be disposed in a radial array about the sleeve 150.

The spring 200 is constrained between (i) a flanged portion 206 formed as a rim, collar, or rib projecting from the exterior peripheral surface of the sleeve 150, and (ii) the spacer 202. The sleeve 150 is fixed or immovable, while the spacer 202 is slidably disposed about the exterior peripheral surface of the sleeve 150. The spacer 202 is ring-shaped and is configured to interface with and contact the balls 204A-204B. The spring 200 applies a force on the spacer 202 in the proximal direction, and thus the spacer 202 in turn applies a force on the balls 204A-204B in the proximal direction as well.

Further, the piston 154 defines a groove 208 on the exterior peripheral surface of the piston 154, and the groove 208 operates as a detent. In other example implementations, rather than the groove 208, the exterior peripheral surface of the piston 154 may include holes corresponding to the balls of the detent mechanism. In operation, as the operator pulls the knob 148 in the proximal direction, and accordingly pulls the piston 154 via the roll pins 155A, 155B, the groove 208 becomes aligned with the balls (e.g., the balls 204A, 204B). Under spring pressure from the spring 200 pushing the spacer 202 in the proximal direction, the spacer 202 pushes the balls causing the balls to move partially in, and engage with, the groove 208.

FIG. 2B illustrates the valve 100 locked in an open state with the detent mechanism in an engaged state, in accordance with an example implementation. As described above, when the operator pulls the knob 148, the piston 154 is also pulled via the roll pins 155A, 155B. As the piston 154 moves axially, the balls 204A, 204B engage with the groove 208 due to action of the spring 200 on the spacer 202, and action of the spacer 202 on the balls 204A, 204B.

The pin 158 follows the piston 154 as a result of the pressurized fluid in the longitudinal channel 140 applying a force on the pin 158 and/or due to engagement between the piston 154 and the pin 158 via the wire 180. As described above, axial motion of the pin 158 causes the armature 138 to move axially, thus causing the second poppet 120 to move off the seat 122. The first poppet 116 follows the second poppet 120 moving off the seat 118 as shown in FIG. 2B, and the valve 100 is open where fluid is allowed to flow from the second port 114 to the first port 112.

If the operator releases the knob 148, the piston 154 does not return back (e.g., does not move in the distal direction) because the spring 200 maintains pressure on the spacer 202, which maintains respective pressure on the balls 204A, 204B, thus holding the piston 154 in position. With this configuration, the piston 154 is locked in place even when the knob 148 is released, and the valve 100 is thus locked in the open state.

As depicted in FIG. 2B, while the valve 100 is in the open state and the detent mechanism is engaged, the airgap 146 shrinks to a small gap 210. For instance, the small gap could be about 0.01 inches; however, other values are possible. Configuring the valve 100 to have the gap 210 when the detent mechanism is engaged, precludes the armature 138 from ending its stroke, i.e., contacting the pole piece 144, prior to the balls 204A, 204B snapping into place within the groove 208 to lock the piston 154. In other words, having the gap 210 ensures that the detent mechanism is engaged prior to the armature 138 reaching the end of its stroke.

To unlock the detent mechanism, additional force may be applied to the knob 148 in the distal direction (to the right in FIG. 2B) to push the balls 204A, 204B out of the groove 208, thus allowing the piston 154 to move in the distal direction.

The pressure-balanced configuration of the pull-type manual actuation mechanism 106 simplifies the detent mechanism described above. Particularly, the pressure-balanced configuration of the pull-type manual actuation mechanism 106 enables the valve 100 to operate with a soft spring, i.e., the spring 164. Thus, the detent mechanism holds the piston 154 locked against the small force caused by the spring 164. As such, the spring 200 may also be a soft spring, and no additional components or operations are used to hold the balls 204A, 204B in the detent (e.g., in the groove 208).

Without the piston 154 being pressure-balanced, the spring 164 would have been a stiff spring applying a large force on the piston 154 in the closing direction. In this case, the spring 200 would have been a stiff spring and additional components and operations may be implemented to ensure that the balls 204A, 204B remain engaged with the groove 208 when the knob 148 is released. Thus, the pressure-balanced configuration of the pull-type manual actuation mechanism 106 may reduce the cost and complexity of the valve 100.

The configurations and components shown in FIGS. 1A-1B and 2A-2B are examples for illustration, and different configurations and components could be used. For example, different types of springs could be used. The knob 148 may be replaced by any type of collar coupled to a lever for manual actuation. Also, the detent mechanism shown in FIGS. 2A-2B may be used in some configurations and applications, and might not be used in others. In other examples, several components may be integrated into a single component rather than having separate components to simplify the valve 100. As a specific example, the spacer 156 may be integrated with the solenoid tube 136 into a single component as described next.

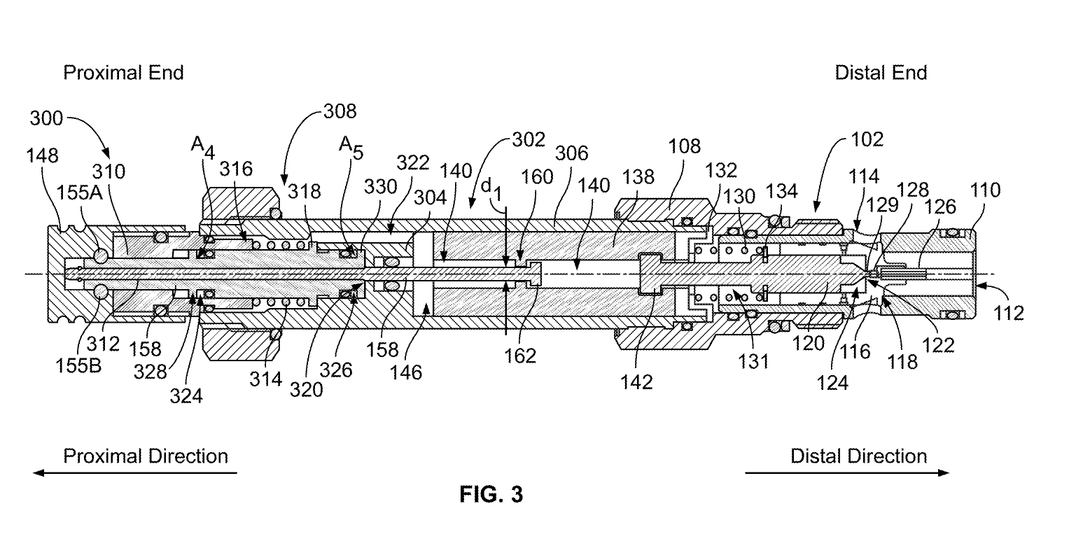

FIG. 3 illustrates a cross-sectional view of a valve 300, in accordance with an example implementation. Similar components between the valve 100 and the valve 300 are designated with the same reference numbers. As shown, the main valve section 102 is the same between the valve 100 and the valve 300. The valve 300 includes a pull-type solenoid actuator mechanism 302 that is similar to the pull-type solenoid actuator mechanism 104, except that the spacer 156 is integrated with the pole piece 144 to form a pole piece 304, which is a portion of a solenoid tube 306 shown in FIG. 3.

The valve 300 includes a pull-type manual actuation mechanism 308 having the knob 148 that defines a longitudinal cylindrical cavity therein. A sleeve 310 is fixedly disposed partially in the cavity defined within the knob 148 and partially in a cavity defined within a proximal end of the solenoid tube 306. The sleeve 310 is coaxial with the knob 148 and the solenoid tube 306.

Further, the sleeve 310 defines a respective longitudinal cylindrical cavity therein and houses a piston 312 that is axially movable within the longitudinal cylindrical cavity of the sleeve 310. The piston 312 may include grooves on an exterior peripheral surface thereof that correspond to respective grooves in the interior peripheral surface of the knob 148, such that the roll pins 155A and 155B are disposed partially in the grooves of the piston 312 and partially in the grooves of the knob 148. With this configuration, the knob 148 is coupled to the piston 312, such that moving the knob 148 axially, e.g., to the left in FIG. 3, causes the piston 312 to move axially therewith.

The piston 312 also defines therein a respective longitudinal cylindrical cavity that houses the pin 158. The pull-type manual actuation mechanism 308 further includes a spring 314 disposed about an exterior peripheral surface of the piston 312 within the cavity defined by the solenoid tube 306. The spring 314 is supported between a distal end 316 of the sleeve 310 and a flanged portion 318 defined as a rim, collar, or rib projecting from the exterior peripheral surface of the piston 312.

The sleeve 310 is fixed, whereas the piston 312 is axially movable therein. Thus, the spring 314 applies a force on the piston 312 that maintains the piston 312 biased in the distal direction.

Further, the piston 312 defines a shoulder 320 against which the pin 158 rests.

Specifically, the pin 158 may define an area with an enlarged diameter that rests against the shoulder 320, such that forces applied to the pin 158 in the proximal direction are transferred to the piston 312 via the shoulder 320.

In operation, as described above with respect to the valve 100, the pressurized fluid received at the second port 114 through unsealed spaces to the longitudinal channel 140. The pressurized fluid in the longitudinal channel 140 applies a force on the pin 158 in the proximal direction, where the force is equal to PA₁. This force acts in the first (proximal) axial direction, and is transferred to the piston 312 via the shoulder 320.

The solenoid tube 306 further includes a hole 322 (e.g., a drilled hole) that is configured to receive the pressurized fluid from the longitudinal channel 140 and communicate the pressurized fluid through an unsealed space between the interior peripheral surface of the pole piece 304 and the exterior peripheral surface of the piston 312 to a first groove 324 and a second groove 326 defined in the exterior peripheral surface of the piston 312. The first groove 324 is bounded by a flanged portion 328 and the second groove 326 is bounded by a flanged portion 330 defined at a distal end of the piston 312.

The pressurized fluid thus applies a force on an annular surface area “A₄” of the flanged portion 328 in the first (proximal) axial direction, and applies a force on an annular surface area “A₅” of the flanged portion 330 in the second (distal) axial direction opposite the first (proximal) axial direction. Therefore, the resultant force acting on the piston 312 can be estimated by the following equation

F=PA₁+PA₄−PA₅P(A₁+A₄−A₅) (2)

In an example, A4 could be equal to A2, and A5 may be equal to A3. However, in another example, A4 might not be equal to A2, and A5 might not be equal to A3. In either example, the area difference A₅−A₄ is substantially equal to the area A₁. The term “substantially” is used herein to indicate that the area difference A₅−A₄ is equal to the area A₁ or within a threshold area or percentage area (e.g., ±1-3%) from the area A₁. As a result, +A₄−A₅) is substantially equal to zero, and thus the force “F” defined by equation (2) is substantially equal to zero (e.g., within a threshold force value, such as 1 lbs, from zero lbs).

As such, the piston 312 is similar to the piston 154 in that the piston 312 is pressure-balanced as the pressurized fluid exerts opposing forces on the piston 312 on surface areas that are selected such that the resultant force exerted on the piston 312 is substantially equal to zero. With this configuration, the spring 314 could be a soft spring having a small spring rate that is sufficient to bias the piston 312 and the pin 158 in the distal direction to maintain the second poppet 120 seated and the valve 100 closed. For example, the spring 314 may exert a small force in a range between 2 lbs and 4 lbs.

As such, the valve 300 represents a variation in the configuration of the components relative to the valve 100. With the configuration shown in FIG. 3, the valve 300 is shorter than the valve 100 as the valve 300 does not include an elongated chamber that houses the detent mechanism shown in FIGS. 2A-2B. However, in other examples, the detent mechanism could also be added to the valve 300.

Further, the valve 300 does not include the spacer 156; rather, the pole piece 304 and the solenoid tube 306 are different from the pole piece 144 and the solenoid tube 136, respectively, such that the spacer 156 is integrated in the solenoid tube 306. The solenoid tube 306, however, includes the hole 322, which operates as a channel or passage to communicate fluid to the surfaces areas A₄ and A₅ as described above.

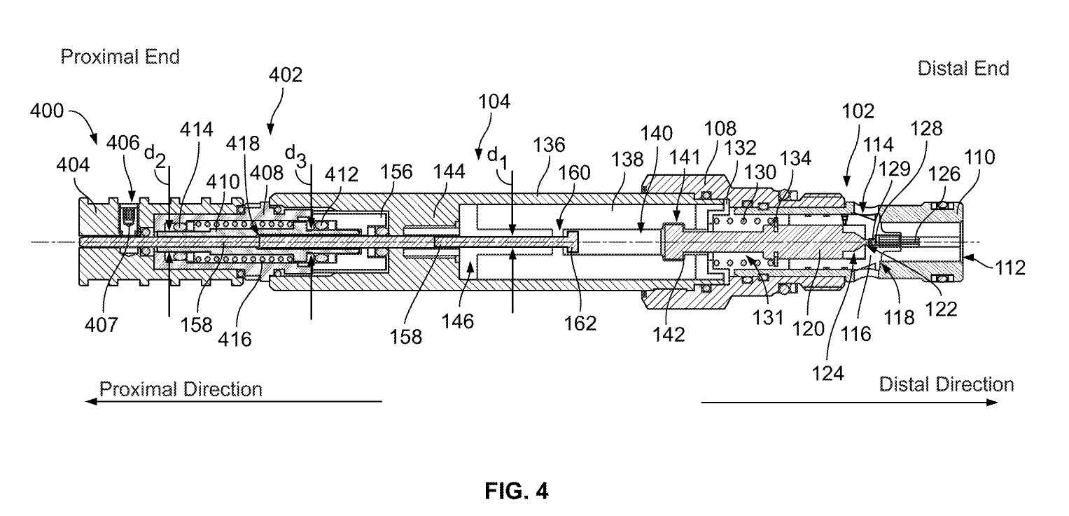

FIG. 4 illustrates a cross-sectional view of another valve 400, in accordance with an example implementation. Similar components between the valve 100, 300, and the valve 400 are designated with the same reference numbers. As shown, the main valve section 102 and the pull-type solenoid actuation mechanism 104 are substantially similar between the valve 100 and the valve 400.

The valve 400 includes a pull-type manual actuation mechanism 402 having a knob 404 that defines a longitudinal cylindrical cavity therein. The knob 404 has a threaded blind hole 406 configured to receive a set screw 407 that then engages and grabs the pin 158. With this configuration, as the knob 404 is pulled axially in the proximal direction (e.g., to the left in FIG. 4), the pin 158 also moves axially along with the knob 404. This configuration is an alternative to the configuration described above including the roll pins 155A, 155B and the wire 180. Other configurations are also possible.

A sleeve 408 is fixedly disposed partially in the cavity defined within the knob 404 and partially in a cavity defined within a proximal end of the solenoid tube 136. The sleeve 408 is coaxial with the knob 404 and the solenoid tube 136.

Further, the sleeve 408 defines a respective longitudinal cylindrical cavity therein and houses a piston 410 that is axially movable within the longitudinal cylindrical cavity of the sleeve 408. The piston 410 has a different configuration compared to the pistons 154, 312; however, similar to the pistons 154, 312, the piston 410 is also pressure-balanced.

Particularly, similar to the valve 100 and as similarly described above with respect to FIGS. 1A-1B, pressurized fluid received at the second port 114 is communicated as described above through unsealed spaces to chambers or spaces formed between the spacer 156 and the piston 410 and between the sleeve 408 and the piston 410. The pressurized fluid then acts on a cross sectional area characterized by diameter “d₂” in the proximal direction and acts on a cross sectional area characterized by diameter “d₃” in the distal direction. The difference between the cross sectional area characterized by the diameter “d₃” and the cross sectional area characterized by the diameter “d₂” is substantially equal to the cross sectional area of the pin 158 characterized by the diameter “d₁” on which the pressurized fluid in the longitudinal channel 140 acts in the proximal direction. As a result, the piston 410 is pressure-balanced.

A first seal 412 is disposed about the piston 410, and specifically about a section of the piston 410 having the diameter “d₃,” whereas a second seal 414 is disposed about the piston 410, and specifically about a section of the piston 410 having the diameter “d₂.” The seals 412, 414 are disposed about sections of the piston 410 having diameters that could be less than respective diameters about which corresponding seals of the valve 100, 300 are disposed. As such, the piston 410 may be subjected to less friction forces from the seals 412, 414 as the piston 410 move axially because the seals 412, 414 may cause friction about a smaller circumferential area compared to the seals in the valves 100, 300.

The valve 400 further includes a spring 416 disposed in a chamber formed between the interior peripheral surface of the sleeve 408 and the exterior peripheral surface of the piston 410. The spring 416 corresponds to the spring 164 of the valve 100 and the spring 314 of the valve 300. However, the springs 164, 314 are disposed in respective chambers that are subjected to the atmosphere or the environment around their respective valves 100, 300. On the other hand, the chamber housing the spring 416 is isolated from the atmosphere or the environment of the valve 400 by way of the seal 414. The chamber that houses the spring 416 may be filled with hydraulic oil during operation of the valve 400. With this configuration, the probability of corrosion of the spring 416 may be reduced.

The piston 410 defines therein a respective longitudinal cylindrical cavity that houses the pin 158. The piston 410 further defines a shoulder 418 (similar to the shoulders 170, 320) against which the pin 158 rests. Specifically, the pin 158 may define an area with an enlarged diameter that rests against the shoulder 418, such that forces applied to the pin 158 in the proximal direction are transferred to the piston 410 via the shoulder 418.

Further, as the knob 404 is pulled in the proximal direction, the pin 158 is pulled therewith as described above, and the pin 158 interacts with the piston 410 via the shoulder 418 to cause the piston 410 to move axially with the knob 404 and the pin 158 against the force of the spring 416. Due to the pressure-balanced configuration of the piston 410, the spring 416 may have a smaller spring rate and may be configured to apply a smaller force (e.g., 6 lbs) on the piston 410 in the distal direction compared to a non-pressure-balanced configuration.

FIG. 4 illustrates the valve 400 without a detent mechanism. However, in other example implementations, a detent mechanism could be added to the valve 400.

The configuration of the valves 300, 400 thus represents example variations from the valve 100, and other configurations are also possible. Regardless of the details of construction of the pull-type solenoid actuator mechanisms 104, 302 and the pull-type manual actuation mechanisms 106, 308, and 402, the knob 148 or 404 is coupled to a pressure-balanced piston (e.g., the piston 154, 312, 410). The pressure-balanced piston configuration enhances operation of the pull-type manual actuation mechanism 106, 308, 402, reduces complexity of the detent mechanism if the valve includes such a detent mechanism, and achieves consistent operation of the valve regardless of the inlet pressure level at the second port 114.

Further, the valves 100, 300, and 400 are shown as poppet valves; however, the pull-type manual actuation mechanisms 106, 308, 402 having respective pressure-balanced pistons could also be implemented for other valve configurations. For instance, the pull-type manual actuation mechanisms 106, 308, 402 described herein could be coupled to a spool of a spool valve to enhance manual actuation of the spool, reduce complexity of the spool valve, and achieve consistent operation regardless of an inlet pressure level. As such, the description above with respect to the pull-type manual actuation mechanisms can be applied to any valve with axially or longitudinally movable element(s), whether the movable element(s) are poppets or spools.

Further, the valves 100, 300, 400 are represented as electrically actuated valves having the pull-type solenoid actuator mechanisms 104, 302, with the pull-type manual actuation mechanisms 106, 308, 402 being used as manual override mechanisms that are used when the pull-type solenoid actuator mechanism 104, 302 fails. However, in other example implementations, the pull-type manual actuation mechanisms 106, 308, 402 could be the primary actuation mechanisms. For instance, the pull-type manual actuation mechanisms 106, 308, 402 could be directly coupled to the second poppet 120, without having the pull-type solenoid actuator mechanisms 104, 302 disposed between the main valve section 102 and the pull-type manual actuation mechanisms 106, 308, 402. As such the pull-type manual actuation mechanisms 106, 308, 402 could be the primary actuation mechanism, and the pressure-balanced configurations of the pull-type manual actuation mechanisms 106, 308, 402 enhance operation of a manually actuated valve, reduce its complexity, and achieve consistent performance.

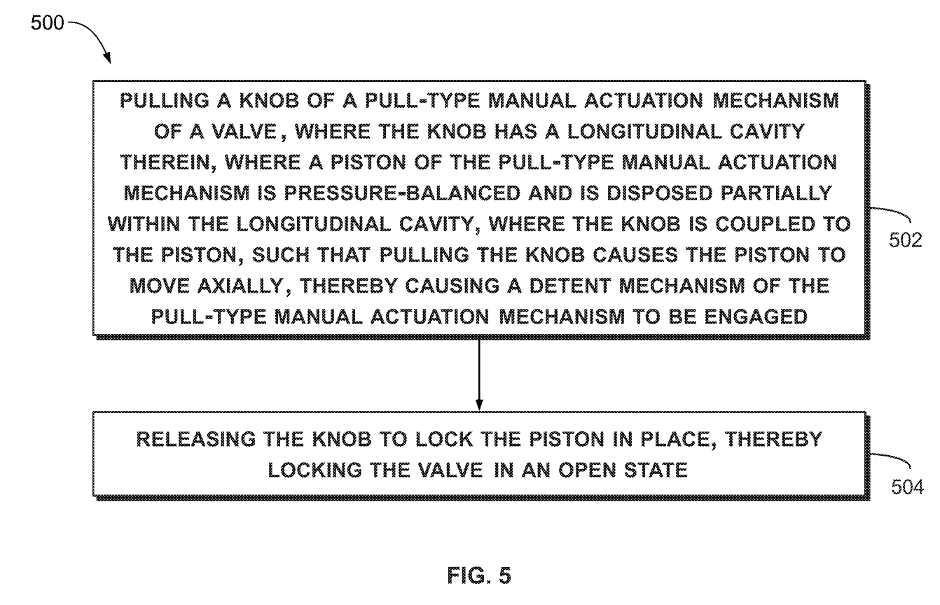

FIG. 5 illustrates a flowchart of an example method of operating a valve, in accordance with an example implementation. Method 500 shown in FIG. 5 presents an example of a method that could be used with any of the valves (e.g., the valves 100, 300, 400) described above and shown in FIGS. 1A-4, for example. The method 500 may include one or more operations, functions, or actions as illustrated by one or more of blocks 502-504. Although the blocks are illustrated in a sequential order, these blocks may also be performed in parallel, and/or in a different order than those described herein. Also, the various blocks may be combined into fewer blocks, divided into additional blocks, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 502, the method 500 includes pulling the knob 148, 404 of the pull-type manual actuation mechanism 106, 308, 402 of the valve 100, 300, 400 where the knob 148, 404 has a longitudinal cavity therein, where the piston 154, 312, 410 of the pull-type manual actuation mechanism 106, 308, 402 is pressure-balanced and is disposed partially within the longitudinal cavity, where the knob 148, 404 is coupled to the piston 154, 312, 410 directly or indirectly via the pin 158 such that pulling the knob 148, 404 causes the piston 154, 312, 410 to move axially, thereby causing a detent mechanism of the pull-type manual actuation mechanism 106, 308, 402 to be engaged. As described above, in an example, the valve may be a manually-actuated and may have the pull-type manual actuation mechanism 106, 308, 402. In other examples, the valve may be actuated by a solenoid or may be pneumatically or hydraulically actuated. In these examples, the valve may include the pull-type manual actuation mechanism 106, 308, 402 for manual override if a primary actuation mechanism does not operate properly. The pull-type manual actuation mechanism 106, 308, 402 are configured such that the pistons 154, 312, 410 are pressure-balanced as described above.

The pull-type manual actuation mechanism 106, 308, 402 may include the detent mechanism described above with respect to FIGS. 2A-2B. As such, pulling the knob 148, 404 may cause the groove 208 disposed on the external peripheral surface the piston 154, 312, 410 to be aligned with the balls 204A, 204B. The spring 200 may push the spacer 202, which pushes the balls 204A, 204B into the groove 208, and the detent mechanism is thus engaged.

As mentioned above, pulling the knob 148, 404 causes the pin 158 to move therewith. The pin 158 causes the armature 138 to move axially, thus causing the movable elements (e.g., the first and second poppets 116, 120) of the valve 100, 300, 400 to move, thereby opening the valve 100, 300, 400 and allowing fluid to flow from the second port 114 to the first port 112.

At block 504, the method 500 includes releasing the knob 148, 404 to lock the piston 154, 312, 410 in place, thereby locking the valve 100, 300, 400 in an open state. The detent mechanism precludes the piston 154, 312, 410 from returning return back (e.g., moving in the distal direction) because the spring 200 maintains pressure on the spacer 202, which maintains respective pressure on the balls 204A, 204B, thus holding the piston 154, 312, 410 in position. With this configuration, the piston 154, 312, 410 is locked in place even when the knob 148,404 is released, and the valve 100, 300, 400 is thus locked in the open state.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

What is claimed is:

1. A pull-type manual actuation mechanism for a valve, the pull-type manual actuation mechanism comprising:
a piston having: (i) a first flanged portion with a first annular surface area, (ii) a second flanged portion with a second annular surface area, wherein the first flanged portion and the second flanged portion project from an exterior peripheral surface of the piston, (iii) a longitudinal cavity bounded by an interior peripheral surface of the piston, and (iv) a shoulder on the interior peripheral surface of the piston; and
a pin disposed in the longitudinal cavity of the piston, wherein the pin has an area with an enlarged diameter configured to interface with and rest against the shoulder of the piston, such that a force applied on the pin in a given axial direction is transferred to the piston, and wherein a difference between the second annular surface area of the second flanged portion and the first annular surface of the first flanged portion is substantially equal to a cross-sectional area of the pin.

2. The pull-type manual actuation mechanism of claim 1, wherein the longitudinal cavity is a first longitudinal cavity, and wherein the pull-type manual actuation mechanism further comprises:
a knob having a second longitudinal cavity therein, wherein the piston is disposed in the second longitudinal cavity of the knob, and wherein the knob is coupled to the piston such that as the knob is pulled in the given axial direction, the piston moves in the given axial direction along with the knob.

3. The pull-type manual actuation mechanism of claim 2, wherein the knob defines a groove on an interior peripheral surface of the knob, wherein the piston defines a groove on the exterior peripheral surface of the piston, and wherein the pull-type manual actuation mechanism further comprises:
a roll pin disposed partially in the groove of the knob and partially in the groove of the piston to couple the piston to the knob.

4. The pull-type manual actuation mechanism of claim 2, further comprising:
a sleeve disposed in the second longitudinal cavity coaxial with the knob, wherein the sleeve has a third longitudinal cavity therein, wherein the piston is disposed, and is axially movable, within the third longitudinal cavity of the sleeve.

5. The pull-type manual actuation mechanism of claim 4, wherein the given axial direction is a first axial direction, and wherein the pull-type manual actuation mechanism further comprises:
a spring disposed about the exterior peripheral surface of the piston such that the spring applies a spring force on the piston in a second axial direction opposite the first axial direction.

6. The pull-type manual actuation mechanism of claim 5, wherein the spring is disposed between the first flanged portion and a respective shoulder defined on an interior peripheral surface of the sleeve.

7. The pull-type manual actuation mechanism of claim 4, further comprising a detent mechanism, wherein the detent mechanism comprises:
a plurality of balls disposed in a radial array about the sleeve;
a spacer that is ring-shaped and interfacing with the plurality of balls; and
a spring disposed about an exterior peripheral surface of the sleeve between: (i) a respective shoulder projecting from the exterior peripheral surface of the sleeve, and (ii) the spacer, wherein the piston includes a groove defined on the exterior peripheral surface of the piston, such that as the piston moves in the given axial direction, the spring pushes the spacer in the given axial direction, and the spacer pushes the plurality of balls causing the plurality of balls to move partially in the groove so as to lock the piston in place relative to the sleeve.

8. A pull-type manual actuation mechanism for a valve, the pull-type manual actuation mechanism comprising:
a knob having a first longitudinal cavity therein;
a sleeve disposed in the first longitudinal cavity coaxial with the knob, wherein the sleeve has a second longitudinal cavity therein;
a piston disposed in the second longitudinal cavity coaxial with the sleeve, wherein the knob is coupled to the piston such that as the knob is pulled in a given axial direction, the piston moves in the given axial direction along with the knob, wherein the piston has: (i) a first flanged portion having a first annular surface area, (ii) a second flanged portion having a second annular surface area, wherein the first flanged portion and the second flanged portion project from an exterior peripheral surface of the piston, (iii) a third longitudinal cavity bounded by an interior peripheral surface of the piston, and (iv) a shoulder on the interior peripheral surface of the piston; and
a pin disposed and axially movable in the third longitudinal cavity of the piston, wherein an end of the pin is configured to be subjected to pressurized fluid from an inlet of the valve, wherein the pin has an area with an enlarged diameter configured to interface with and rest against the shoulder of the piston, such that a force applied on the end of the pin via the pressurized fluid in the given axial direction is transferred to the piston, and wherein a difference between the second annular surface area of the second flanged portion and the first annular surface of the first flanged portion is substantially equal to a cross-sectional area of the pin.

9. The pull-type manual actuation mechanism of claim 8, wherein the knob defines a groove on an interior peripheral surface of the knob, wherein the piston defines a groove on the exterior peripheral surface of the piston, and wherein the pull-type manual actuation mechanism further comprises:
a roll pin disposed partially in the groove of the knob and partially in the groove of the piston to couple the piston to the knob.

10. The pull-type manual actuation mechanism of claim 8, wherein the given axial direction is a first axial direction, and wherein the pull-type manual actuation mechanism further comprises:
a spring disposed about the exterior peripheral surface of the piston such that the spring applies a spring force on the piston in a second axial direction opposite the first axial direction.

11. The pull-type manual actuation mechanism of claim 10, wherein the spring is disposed between (i) a third flanged portion projecting from the exterior peripheral surface of the piston, and (ii) an end of the sleeve.

12. The pull-type manual actuation mechanism of claim 8, further comprising a detent mechanism, wherein the detent mechanism comprises:
a plurality of balls disposed in a radial array about the sleeve;
a spacer that is ring-shaped and interfacing with the plurality of balls;
a spring disposed about an exterior peripheral surface of the sleeve between: (i) a respective shoulder projecting from the exterior peripheral surface of the sleeve, and (ii) the spacer, wherein the piston includes a groove defined on the exterior peripheral surface of the piston, such that as the piston moves in the given axial direction, the spring pushes the spacer in the given axial direction, and the spacer pushes the plurality of balls causing the plurality of balls to move partially in the groove so as to lock the piston in place relative to the sleeve.

13. A valve comprising:
a main valve section comprising: (i) a housing, (ii) a sleeve disposed in the housing, wherein the sleeve defines a first port and a second port, and (iii) a movable element configured to move axially within the sleeve; and
a pull-type manual actuation mechanism comprising:
a knob having a first longitudinal cavity therein;
a piston disposed partially within the first longitudinal cavity, wherein the knob is coupled to the piston, wherein the piston has: (i) a first flanged portion having a first annular surface area, (ii) a second flanged portion having a second annular surface area, wherein the first flanged portion and the second flanged portion project from an exterior peripheral surface of the piston, and (iii) a second longitudinal cavity bounded by an interior peripheral surface of the piston, and (iv) a shoulder on the interior peripheral surface of the piston, and
a pin disposed in the second longitudinal cavity of the piston, wherein the pin is coupled to the movable element of the main valve section, wherein the pin has an area with an enlarged diameter configured to interface with and rest against the shoulder of the piston, such that a force applied on the pin in a given axial direction via pressurized fluid received at the second port acting on a cross-sectional area of the pin is transferred to the piston, and wherein a difference between the second annular surface area of the second flanged portion and the first annular surface area of the first flanged portion is substantially equal to the cross-sectional area of the pin, such that when pressurized fluid is communicated to the first annular surface area and the second annular surface area, the piston is pressure-balanced, and wherein when the knob is pulled in the given axial direction, the piston moves in the given axial direction along with the knob, allowing the pin and the movable element coupled thereto to move in the given axial direction, thereby allowing fluid to flow from the second port to the first port.

14. The valve of claim 13, further comprising:
a pull-type solenoid actuator mechanism comprising:
a solenoid tube disposed partially within the housing of the main valve section; and
an armature disposed within the solenoid tube, wherein the armature is coupled to the movable element and the pin, such that axial motion of the pin in the given axial direction causes the armature to move axially along with the pin, thereby causing the movable element to move axially in the given axial direction.

15. The valve of claim 14, further comprising:
a spacer that is ring-shaped and disposed within the solenoid tube, wherein the piston is disposed partially within and interfaces with the spacer, such that pressurized fluid is allowed to traverse unsealed spaces between the spacer and the solenoid tube and between the piston and the spacer so as to be communicated to the first annular surface area and the second annular surface area.

16. The valve of claim 13, wherein the sleeve is a first sleeve, wherein the pull-type manual actuation mechanism further comprises:
a second sleeve disposed in the first longitudinal cavity coaxial with the knob, wherein the second sleeve has a third longitudinal cavity therein, wherein the piston is disposed, and is axially movable, in the third longitudinal cavity of the second sleeve.

17. The valve of claim 16, wherein the pull-type manual actuation mechanism further comprises a detent mechanism, wherein the detent mechanism comprises:
a plurality of balls disposed in a radial array about the second sleeve;
a spacer that is ring-shaped, slidably disposed about the second sleeve, and interfacing with the plurality of balls;
a spring disposed about an exterior peripheral surface of the second sleeve between: (i) a shoulder projecting from the exterior peripheral surface of the second sleeve, and (ii) the spacer, wherein the piston includes a groove defined on the exterior peripheral surface of the piston, such that as the piston moves in the given axial direction, the spring pushes the spacer in the given axial direction, and the spacer pushes the plurality of balls causing the plurality of balls to move partially in the groove so as to lock the piston in place relative to the second sleeve.

18. The valve of claim 16, wherein the given axial direction is a first axial direction, and wherein the pull-type manual actuation mechanism further comprises:
a spring disposed about the exterior peripheral surface of the piston such that the spring applies a spring force on the piston in a second axial direction opposite the first axial direction, wherein the spring is disposed between the first flanged portion and a respective shoulder defined on an interior peripheral surface of the second sleeve.

19. The valve of claim 13, wherein the knob defines a groove on an interior peripheral surface of the knob, wherein the piston defines a groove on the exterior peripheral surface of the piston, and wherein the pull-type manual actuation mechanism further comprises a roll pin disposed partially in the groove of the knob and partially in the groove of the piston to couple the piston to the knob.

20. The valve of claim 13, wherein the movable element is a first movable element, wherein the main valve section further comprises:
a second movable element configured to be seated on a first seat defined on an interior peripheral surface of the sleeve, wherein when the second movable element is seated on the first seat, the second movable element blocks the second port, wherein the first movable element is disposed within the second movable element, wherein the first movable element is configured to be seated on a second seat defined on an interior peripheral surface of the second movable element, and wherein when the first movable element moves axially off the second seat, the second moveable element follows the first movable element and moves off the first seat, thereby allowing fluid to flow from the second port to the first port.
